(19) United States
(12) Patent Application Publication
(10) Pub. No.: US 2025/0281015 A1
(43) Pub. Date: Sep. 11, 2025

(54) VACUUM TRUCK AND MEHTODS OF OPERATING THE SAME

(71) Applicant: SFSO, LLC, Johnsburg, IL (US)

(72) Inventors: Steve Farris, Box Elder, SD (US); Sean O'Brien, Johnsburg, IL (US)

(73) Assignee: SFSO, LLC, Johnsburg, IL (US)

(21) Appl. No.: 19/071,875

(22) Filed: Mar. 6, 2025

Related U.S. Application Data
(60) Provisional application No. 63/563,167, filed on Mar. 8, 2024.

(51) Int. Cl. A47L 7/00; B08B 9/087; B60K 13/04; B60P 3/22

(52) U.S. Cl. CPC A47L 7/0038; B08B 9/087; B60K 13/04; B08B 2209/08; B60P 3/225

(57) ABSTRACT

A vacuum truck including a truck engine, a tank positioned at the rear end of the vacuum truck, a vacuum pump connected to the tank, an inlet port, and an outlet port, a valve connected to the outlet port of the vacuum pump on first port, an engine exhaust line on a second port and an exhaust line on a third port, an auger in the tank connected to a motor on one end and an outlet port on the other end with the outlet port being connected to the exhaust line.

### CROSS REFERENCE TO RELATED APPLICATIONS

This is application claims the benefit of U.S. Provisional Application 63/563,167 filed Mar. 8, 2024, which is fully incorporated herein by reference.

### BACKGROUND OF THE INVENTION

Liquid and sludge removal-vacuum trucks are equipped with vacuum pumps that can collect liquids like sludges and other material from tanks, pits, sumps and other storage containers. These types of industrial vehicles are typically used in the ethanol, petrochemical, wastewater treatment and mining industries. Vacuum trucks are used to clean and remove material from industrial sites, spills or accidents. Vacuum trucks collect and transport waste materials from industrial sites. Municipalities also use vacuum trucks to clean and maintain sewer systems, septic tanks and sewage treatment plants. The trucks can remove sludge and waste material from sewer lines allowing proper sewer operation to be maintained. Hazardous

Vacuum trucks can also handle hazardous material in a safe manner. Vacuum trucks are equipped with specialty tanks that meet appropriate safety standards to transport and dispose of the hazardous materials. Vacuum trucks are also used to remove and relocate waste material from ethanol related processes or waste material from tank cleansing. Vacuum trucks can also be deployed to remove pollutants and mitigate environmental impact of environmental remediation sites.

Vacuum trucks are capable of removing material via vacuum pumps, storing and transporting the material to a safe disposal area. However, these three functions must occur sequentially leading to efficiency and time consumption. Sequential processes may take longer compared to continuous processes because each step requires stopping and starting the equipment. This can affect overall efficiency and productivity. Depending on the nature of the material being handled, there is a risk of contamination during each transfer step. This is especially true if there are multiple materials being transported in the same vacuum truck.

The start-stop nature of sequential processes can result in increased energy consumption. Frequent stopping and starting of the vacuum pump or other equipment may lead to inefficiencies. Frequent stopping and starting of equipment can contribute to increased wear and tear, requiring more maintenance. This may lead to higher operational costs and downtime. Certain materials may pose challenges during storage or discharge, such as those with sticky or cohesive properties. This can lead to difficulties in complete discharge and may require additional measures to ensure effective material handling. Material handling in a vacuum truck may involve potentially hazardous or environmentally sensitive substances. Any spillage or release during the sequential process could pose safety risks and environmental concerns.

A sequential process involves multiple steps and components, increasing the complexity of the overall system. This complexity may require more sophisticated control systems and may be prone to more points of failure. Operating a vacuum truck with a sequential process may require skilled operators who can effectively manage each step of the process to ensure safe and efficient material handling. The costs associated with implementing and maintaining a vacuum truck system with a sequential process need to be considered. This includes equipment costs, maintenance, and potential downtime.

Therefore, the need exists for a efficient vacuum truck.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a vacuum truck including a truck engine, a tank positioned at the rear end of the vacuum truck, a vacuum pump connected to the tank, an inlet port, and an outlet port, a valve connected to the outlet port of the vacuum pump on first port, an engine exhaust line on a second port and a exhaust line on a third port, an auger in the tank connected to a motor on one end and an outlet port on the other end with the outlet port being connected to the exhaust line.

In another embodiment, the auger motor is powered by the truck engine.

In another embodiment, the vacuum pump is powered by the truck engine.

In another embodiment, the auger is positioned below the debris in the tank.

In another embodiment, the auger includes a first section connected to the outlet port and a second portion connected to the motor.

In another embodiment, the blades on the first portion are shorted than the blades in the second portion.

In another embodiment, the auger pushes the debris through the outlet port without compromising the vacuum on side the tank.

In another embodiment, the vacuum truck includes an inlet port that delivers debris to the tank via the vacuum pressure in the tank.

In another embodiment, the debris is solid.

In another embodiment, n the debris is liquid.

Another embodiment of the present disclosure includes a method of operating a vacuum truck, the method including the steps of creating a vacuum in a tank positioned at the rear end of the vacuum truck via a vacuum pump diverting exhaust from the engine through an exhaust line via a pressure valve, moving debris through a tank outlet via an auger in the tank connected to a motor on one end and the tank outlet on the other end with the outlet port being connected to the exhaust line.

In another embodiment, the auger motor is powered by the truck engine.

In another embodiment, the vacuum pump is powered by the truck engine.

In another embodiment, the auger is positioned below the debris in the tank.

In another embodiment, the auger includes a first section connected to the outlet port and a second portion connected to the motor.

In another embodiment, the blades on the first portion are shorted than the blades in the second portion.

In another embodiment, the auger pushes the debris through the outlet port without compromising the vacuum on side the tank.

In another embodiment, the vacuum truck includes an inlet port that delivers debris to the tank via the vacuum pressure in the tank.

In another embodiment, the debris is solid.

In another embodiment, the debris is liquid.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a mechanical analysis system 100 consistent with the present invention.

FIG. 2 depicts one embodiment of a system analysis unit;

FIG. 3 depicts one embodiment of a communication device consistent with the present invention;

FIG. 4 depicts one embodiment of the auger.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

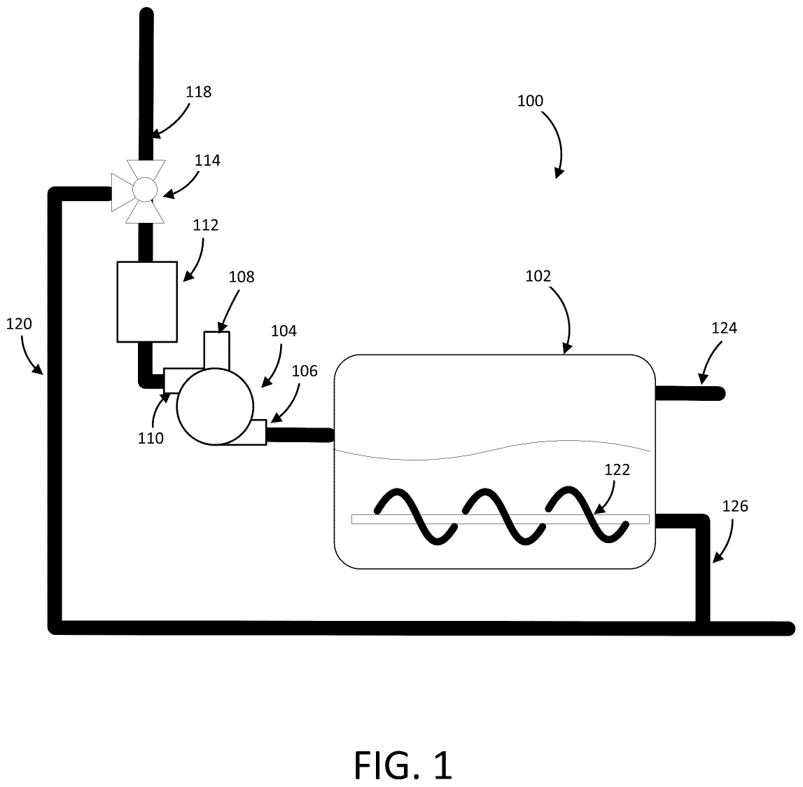

FIG. 1 depicts a schematic representation of a vacuum truck collection and expulsion system 100. The truck collection and expulsion system 100 includes a tank 102 that is fluidly connected to a vacuum pump 104. The tank is made from chemically resistant materials including, but not limited to, steel or aluminum. The vacuum pump 104 maintains a negative pressure in the tank 102 with the vacuum pump 104 including an inlet 106 connected to the tank 102, an intake port 108 to allow the vacuum pump 104 to draw in air to maintain the negative pressure in the tank 102 and an outlet port 110 connected to an air manifold blower unit 112. The air blower unit 112 is connected to the exhaust line of the vacuum truck with the exhaust line being connected to the engine of the vacuum truck. In one embodiment, the vacuum pump 104 is powered by the vacuum truck engine. An outlet of the manifold is connect to a valve 114 with the valve 114 connecting the air blower unit 112 to the engine exhaust 118 and to the purge line 120. In one embodiment, the valve 114 is a pressure valve that redirects the exhaust to the purge line 120. The diversion of the exhaust through the valve 114 operated at the same pressure and airflow generated for the vacuum operation by the vacuum pump 104, the amount of energy required for this additional operation is minimal. The discharge pressure and airflow used to intake the material into the tank 102 is similar to the discharge from the tank 102 allowing substantially equal volumes of material to be simultaneously discharged and collected.

The tank 102 includes an auger 122 that is positioned at the bottom portion of the tank at a position below the material collected by the tank inlet 124. The auger 122 includes a motor that turns the auger with the motor being powered by the vacuum truck engine. The auger is connected to a tank outlet port 126 with the auger moving material form the interior of the tank to the tank outlet port 126 which seals the tank outlet port 126 creating the airlock. The auger 122 is designed in conjunction with the tank outlet port 126. The auger 122 circumference is matched to the opening circumference of the tank outlet port 126 such that the material transference to the exhaust port is continuous during the auger 122 revolution forcing the exhaust pressure to work against the material being conveyed by the auger 122.

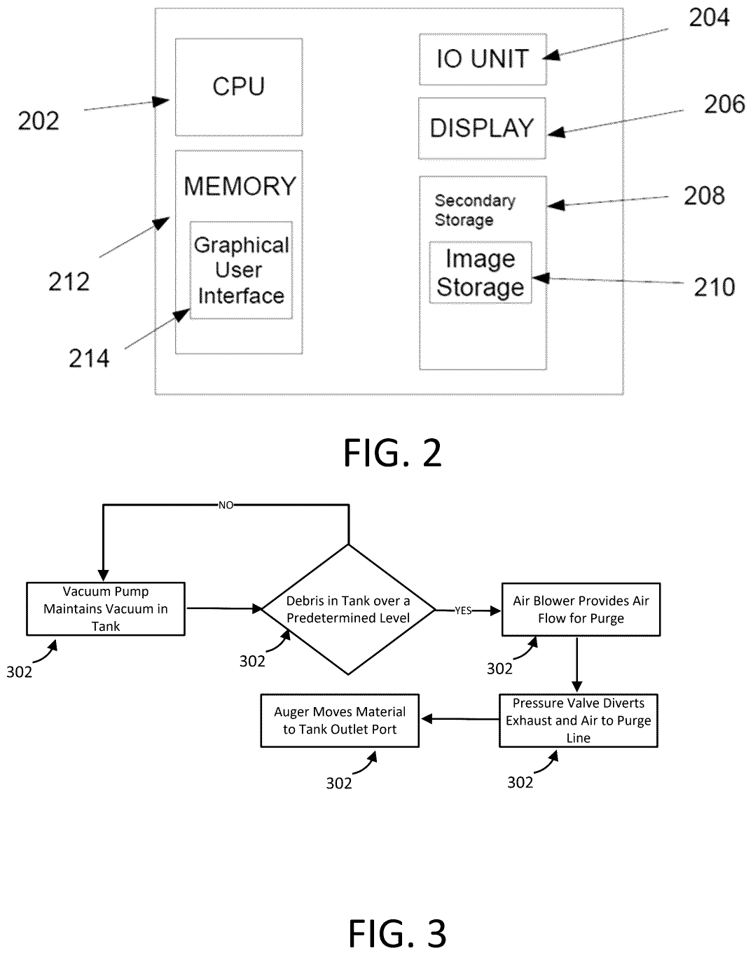

FIG. 2 depicts one embodiment of a control unit 102. The control 102 includes a network I/O device 204, a processor 202, a display 206 and a secondary storage 208 running image storage unit 210 and a memory 212 running a graphical user interface 214. In one embodiment, the processor 202 may be a central processing unit (“CPU”), a specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory 212 may use any type of volatile or non-volatile storage techniques and mediums. The network I/O line 204 device may be a network interface card, a cellular interface card, a plain old telephone service (“POTS”) interface card, an ASCII interface card, or any other suitable network interface device.

FIG. 3 depicts a schematic representation of a vacuum truck system 100. In step 302, a vacuum pump 104 maintains a negative pressure in the tank 102 to allows a flexible hose connected to the port allowing extension to bring material into the tank 102. In one embodiment, a pressure sensor (not shown) in the tank measures the amount of vacuum in the tank. In step 304, the debris level in the tank is monitored to determine if the debris level has exceeded a predetermined set point. If the debris level is below a predetermined setpoint, the vacuum pump continues to maintain a vacuum in the tank. If the debris level is above the predetermined setpoint, the vacuum system enters into a purge mode. In one embodiment, a level sensor in the tank 102 that is connected to the control unit 200 monitors the level in the tank. In step 306, the air blower unit 112 provides are to the purge line 120 via the valve 114. In step 308, the valve modules to provide exhaust and air to the purge line 120 by diverting the exhaust air and air from the blower unit 112 to the purge line.

In step 306, the auger 122 is actuated an moves material from the tank through the tank exhaust outlet port 126. The auger 122 moves the material within the tank 102 to the tank exhaust outlet port 126 which enables the exhaust force created by the valve 114 to force the material to be exhausted from the tank simultaneously as more material is collected. The auger 122 pulls the incoming material to the back of the tank 102 which seals the tank exhaust outlet port 126 creating an airlock. In one embodiment, the material/debris is a solid such as corn. In another embodiment, the material/debris is a liquid such as syrup or tank waste water. In one embodiment, the tank 102 is cleared of material in two hours or less.

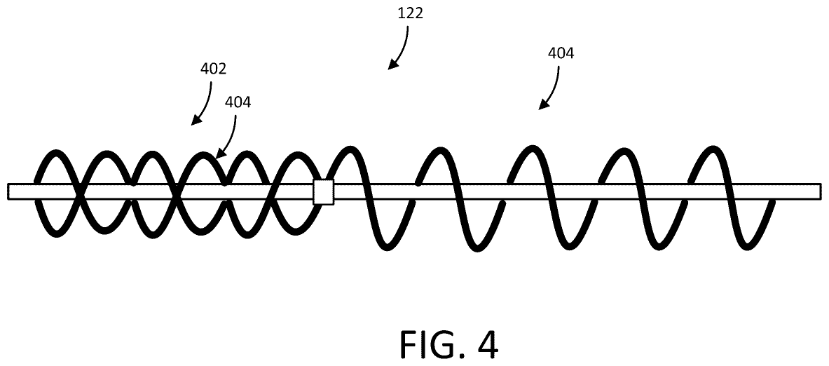

FIG. 4 depicts one embodiment of the auger 122. The auger 122 is includes a first section 402 and a second section 404. The first section 402 includes a plurality of auger blades 406 and the second section 404 includes a second set of auger blades 408. In one embodiment, the auger blades 406 are shorter than the auger blades 408. When installed in the tank 102, the first section 402 is connected to the tank exhaust port 126 and the second section 404 is connected to an motor that turns the auger 122 when in operation

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A vacuum truck including:
a truck engine;
a tank positioned at the rear end of the vacuum truck;
a vacuum pump connected to the tank, an inlet port, and an outlet port;
a valve connected to the outlet port of the vacuum pump on first port, an engine exhaust line on a second port and a exhaust line on a third port;
an auger in the tank connected to a motor on one end and an outlet port on the other end with the outlet port being connected to the exhaust line.

2. The vacuum truck of claim 1, wherein the auger motor is powered by the truck engine.

3. The vacuum truck of claim 1, wherein the vacuum pump is powered by the truck engine.

4. The vacuum truck of claim 1, wherein the auger is positioned below the debris in the tank.

5. The vacuum truck of claim 1, wherein the auger includes a first section connected to the outlet port and a second portion connected to the motor.

6. The vacuum truck of claim 5, wherein the blades on the first portion are shorted than the blades in the second portion.

7. The vacuum truck of claim 1, wherein the auger pushes the debris through the outlet port without compromising the vacuum on side the tank.

8. The vacuum truck of claim 1, including an inlet port that delivers debris to the tank via the vacuum pressure in the tank.

9. The vacuum truck of claim 8 wherein the debris is solid.

10. The vacuum truck of claim 8 wherein the debris is liquid.

11. A method of operating a vacuum truck, the method including the steps of:
creating a vacuum in a tank positioned at the rear end of the vacuum truck via a vacuum pump;
diverting exhaust from the engine through an exhaust line via a pressure valve;
moving debris through a tank outlet via an auger in the tank connected to a motor on one end and the tank outlet on the other end with the outlet port being connected to the exhaust line.

12. The vacuum truck of claim 11, wherein the auger motor is powered by the truck engine.

13. The vacuum truck of claim 11, wherein the vacuum pump is powered by the truck engine.

14. The vacuum truck of claim 11, wherein the auger is positioned below the debris in the tank.

15. The vacuum truck of claim 11, wherein the auger includes a first section connected to the outlet port and a second portion connected to the motor.

16. The vacuum truck of claim 15, wherein the blades on the first portion are shorted than the blades in the second portion.

17. The vacuum truck of claim 11, wherein the auger pushes the debris through the outlet port without compromising the vacuum on side the tank.

18. The vacuum truck of claim 11, including an inlet port that delivers debris to the tank via the vacuum pressure in the tank.

19. The vacuum truck of claim 18 wherein the debris is solid.

20. The vacuum truck of claim 18 wherein the debris is liquid.
